(19) United States
(12) Patent Application Publication
(10) Pub. No.: US 2026/0304138 A1
(43) Pub. Date: Oct. 1, 2026

(54) CHANNEL DEPENDENT ACCESS PRIORITY

(71) Applicant: Telefonaktiebolaget LM Ericsson (publ), Stockholm (SE)

(72) Inventors: Leif WILHELMSSON, Lund (SE); Sebastian MAX, Cologne (DE); Pontus ARVIDSON, Sollentuna (SE)

(21) Appl. No.: 19/483,500

(22) PCT Filed: May 8, 2024
(86) PCT No.: PCT/EP2024/062805

§ 371 Date: Nov. 11, 2025

Related U.S. Application Data
(60) Provisional application No. 63/501,942, filed on May 12, 2023.

(51) Int. Cl. H04W 16/14; H04W 4/80; H04W 74/0808; H04W 84/12

(52) U.S. Cl. CPC H04W 16/14; H04W 74/0808; H04W 4/80; H04W 84/12

(57) ABSTRACT

A method and apparatus are disclosed. An embodiment of a first network node is configured to communicate with a first wireless device on a frequency band, the frequency band being shared with at least one of a second wireless device and second network node. The network node is configured to select at least one parameter of a spectrum sharing scheme, the selection is based on at least one channel in the frequency band targeted for a transmission to the first wireless device. The network node is configured to determine, based on at least one parameter, a portion of the frequency band to be used for initiating the transmission to the first wireless device.

### FIELD

The present disclosure relates to wireless communications, and in particular, to channel dependent access priority.

### INTRODUCTION

When operating in unlicensed bands, e.g., the 2.4 GHz industrial, scientific, and medical (ISM), the 5 GHz band, or the 6 GHz band, some method of spectrum sharing mechanism may be required unless the transmissions are limited to use a very low power. The two most commonly used spectrum sharing mechanisms are listen before talk (LBT) (also referred to as carrier sense multiple access with collision avoidance (CSMA/CA)) and frequency hopping (FH).

The working procedure of LBT may be as follows. Before a transmission can be initiated, the transmitter listens on the channel to determine whether it is idle, or if there is already another transmission ongoing. If the channel is found to be idle, the transmitter initiates the transmission. If the channel is found to be busy, the transmitter defers from transmission and continues to sense the channel until the channel becomes idle. LBT is used by different variants of IEEE 802.11, referred to as Wi-Fi, operating in, e.g., the 2.4 GHz ISM band as well as in the 5 GHz bands. LBT is also employed by standards, e.g., those developed by 3rd Generation Partnership Project (3GPP), operating in the 5 GHz band, e.g., New Radio-Unlicensed (NR-U). If FH is used instead, the spectrum sharing is based on only using a specific part of the band for a relatively small fraction of the total time, leaving room for other transmissions. FH is the approach used, e.g., by Bluetooth.

Typically LBT is used if the used channel bandwidth it relatively large, e.g., 20 MHz or more, and the required usage of the channel is very dynamic with a lot of variance. FH, on the other hand, is typically used for narrowband systems where the occupied bandwidth is much less (e.g., 1 or 2 MHz) and a predictable, deterministic channel usage is required.

Although both LBT and FH can be viewed as effective spectrum sharing mechanisms, both may only work well if all devices are using the same spectrum sharing mechanism, i.e., if all devices use LBT, or they all use FH. However, if some devices use LBT and others use FH, issues may arise. As an example, a wideband system using LBT may detect the narrowband transmission and defer from transmitting, even though such a transmission would have been successful without causing any noticeable harm to the narrowband system. Conversely, the wideband system may not detect a narrowband system, since the average sensed power within the wideband channel is relatively low, and the transmitter may initiate a transmission that may result in harmful interference to the narrowband system.

This conflict arises in the 2.4 GHz ISM band, where Wi-Fi uses LBT and Bluetooth uses FH. To allow for coexistence between the two standards, Bluetooth has developed support for adaptive FH (AFH), whereby the Bluetooth devices detect if there are Wi-Fi transmissions on some of the Wi-Fi channels and then adapt the hopping pattern used for FH such that the frequencies coinciding with a Wi-Fi channel are not used. In Bluetooth Low Energy (BLE), additional specific measures may be taken to limit the interference to Wi-Fi by only using three channels for the initial link establishment. These three channels are selected such that they will not overlap with the three most commonly used Wi-Fi channels (Channel 1, 6 and 11).

AFH has at least two limitations. The first is that it by necessity takes some time to determine whether a frequency channel should be considered as occupied by, e.g., Wi-Fi, and therefore should not be used. It also takes time to determine when the channel is no longer occupied and available for use. How long this takes may also depend on how much the channel is used. If a Wi-Fi channel is only used, e.g., 10% of the time, many Bluetooth transmissions may be needed in order to determine that, in fact, the channel is used for Wi-Fi transmissions. If allocation and usage of Wi-Fi channels are relatively static, this problem may be less severe. The second limitation is that AFH may only be practical when it is possible to find channels that are free from interference. If, for instance, Wi-Fi uses an 80 MHz channel in the ISM band (which may not be allowed), AFH would not work since there are no channels remaining.

The second limitation, i.e., that the wideband system uses a channel that covers the entire bandwidth of the system using FH, may, however, still be a problem when employing Bluetooth in, e.g., the 6 GHz band using a total bandwidth about 80 MHz, just like in the 2.4 GHz band. In the 6 GHz band, Wi-Fi may use 80 MHz, 160 MHz, or even more in future implementations. This means that AFH may not work as intended. In addition, the Wi-Fi transmitter may detect every Bluetooth transmission and defer from transmitting due to the LBT procedure.

Thus, a problem is caused by the use of two different spectrum sharing strategies, each designed assuming that all devices adhere to it. When this condition is not fulfilled, at least one and potentially both the spectrum sharing strategies may not work as desired. Specifically, due to the use of different bandwidths, the sharing will likely be unfair and ineffective. In the case of the narrowband system interfering with the wideband system, even if only very small part of the wideband signal is interfered with, such interference may still ruin the performance. To avoid this, the narrowband system may have to use a very low threshold for declaring the channel to be idle, which in turn may severely degrade the performance of the narrowband system. In the case of the wideband system interfering with the narrowband system, a single wideband transmission can interfere with multiple narrowband transmission, either by preventing them from taking place due to the narrowband LBT or by causing detrimental interference to them if the sensing threshold for the wideband system is not set sufficiently low.

### SUMMARY

Some embodiments advantageously provide methods, systems, and apparatuses for channel dependent access priority. Aspects are provided in the independent claims, and embodiments thereof are provided in the dependent claims.

To enhance the coexistence between a FH system and a wideband system using LBT, such as, e.g., Wi-Fi, the FH system may be configured to use a form of LBT. Specifically, for the FH system, before transmitting on a narrow band signal on a new frequency, the transmitter first checks whether the narrowband channel is idle or busy. If the channel is idle, the transmission is performed, but if the channel is busy, no transmission is performed on this frequency, and instead the transmitter hops to the next frequency according to the frequency hopping pattern. While this may indicate the FH system does not interfere with the wideband system, it may introduce additional delay because the number of transmission opportunities will effectively be reduced. One view is that if the channel is found to be busy, the transmission may have failed, but typically at least some of the transmission would have been successful.

A spectrum sharing approach for two systems using different bandwidths and different forms of LBT is described herein. In one or more embodiments, the two systems may be different non-cellular or non-3GPP based systems. This LBT algorithm for the narrowband system may be characterized such that, that for some part of the frequency band, the narrowband system is more likely to win a contention with the wideband system than in another part of the frequency band. Specifically, in the first part of the band, the narrowband system has priority, whereas in the second part of the band, the wideband system has priority. The size of the first and the second part of the band can be changed dynamically so that the total bandwidth of the frequency band can be shared in a way that accounts for actual loads in the respective systems.

One or more embodiments described herein allows for a low complexity yet efficient way to support sharing of a frequency band between two different systems. The sharing may be achieved by designing the channel sharing mechanisms for the two systems jointly, or it may be achieved by designing only the first system's channel sharing mechanism by taking the channel sharing mechanism for the second system into account. The latter approach allows the channel sharing mechanism to be introduced in situations where the second system is already deployed in the frequency band.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system according to principles disclosed herein;

FIG. 2 is a block diagram of a network node in communication with a wireless device over a wireless connection according to some embodiments of the present disclosure;

FIG. 3 is a flowchart of an example process in a network node according to some embodiments of the present disclosure;

FIG. 4 is a flowchart of an example process in a wireless device according to some embodiments of the present disclosure;

FIG. 5 is a block diagram according to some embodiments of the present disclosure;

FIG. 6 is a block diagram according to some embodiments of the present disclosure; and

FIG. 7 is a block diagram according to some embodiments of the present disclosure.

### DETAILED DESCRIPTION

Before describing in detail example embodiments, it is noted that the embodiments reside primarily in combinations of apparatus components and processing steps related to channel dependent access priority. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node. The network node may also comprise test equipment. In some embodiments, the network node may comprise a radio router, a radio transceiver, WiFi access point, wireless local area network (WLAN) access point, a network controller, a Bluetooth transceiver, etc.

In some embodiments, the non-limiting terms wireless device (WD) or a user equipment (UE) are used interchangeably. In some embodiments, the device may be and/or comprise an access point (AP) station (STA). In some embodiments, the device may be and/or comprise a non-access point station (non-AP STA) The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Note also that some embodiments of the present disclosure may be supported by an Institute of Electrical Engineers (IEEE) 802.11 standard. IEEE 802.11 denotes a set of Wireless Local Area Network (WLAN) air interface standards developed by the IEEE 802.11 committee for short-range communications (e.g., tens of meters to a few hundred meters). Some embodiments may also be supported by standard documents disclosed in Third Generation Partnership Project (3GPP) technical specifications. That is, some embodiments of the description can be supported by the above documents. In addition, all the terms disclosed in the present document may be described by the above standard documents.

Note that although terminology from one particular wireless system, such as, for example, Bluetooth, IEEE 802.11, 3GPP, Long Term Evolution (LTE), 5th Generation (5G) and/or New Radio (NR) may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

In some embodiments, the general description elements in the form of “one of A and B” corresponds to A or B. In some embodiments, at least one of A and B corresponds to A, B or AB, or to one or more of A and B, or one or both of A and B. In some embodiments, at least one of A, B and C corresponds to one or more of A, B and C, and/or A, B, C or a combination thereof.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments are directed to channel dependent access priority.

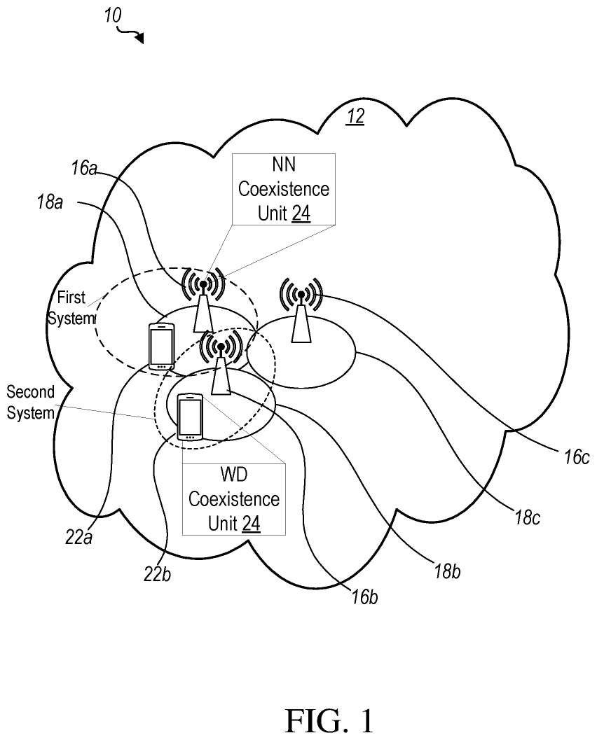

Referring to the drawing figures, in which like elements are referred to by like reference numerals, there is shown in FIG. 1 a schematic diagram of a communication system 10, according to an embodiment, such as a wireless local area network (WLAN) that may support standards such as, for example, IEEE 802.11 and/or Bluetooth and/or other non-cellular standards/specifications, which comprises an access network 12, such as a radio access network. The access network 12 comprises a plurality of network nodes 16a, 16b, 16c (referred to collectively as network nodes 16), or other types of wireless access points, each defining a corresponding coverage area 18a, 18b, 18c (referred to collectively as coverage areas 18). A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16.

A network node 16 is configured to include a network node (NN) coexistence unit 24 which is configured to perform one or more network node 16 functions described herein, including functions related to channel dependent access priority. A wireless device 22 is configured to include a wireless device (WD) coexistence unit 26 which is configured to perform one or more wireless device 22 functions described herein, including functions related to channel dependent access priority.

A first system may comprise one or more network nodes 16 communicating with one or more wireless devices 22 using a first standard, e.g., Wi-Fi. A second system may comprise one or more network nodes 16 communicating with one or more wireless devices 22 using a second standard different from the first standard, e.g., Bluetooth.

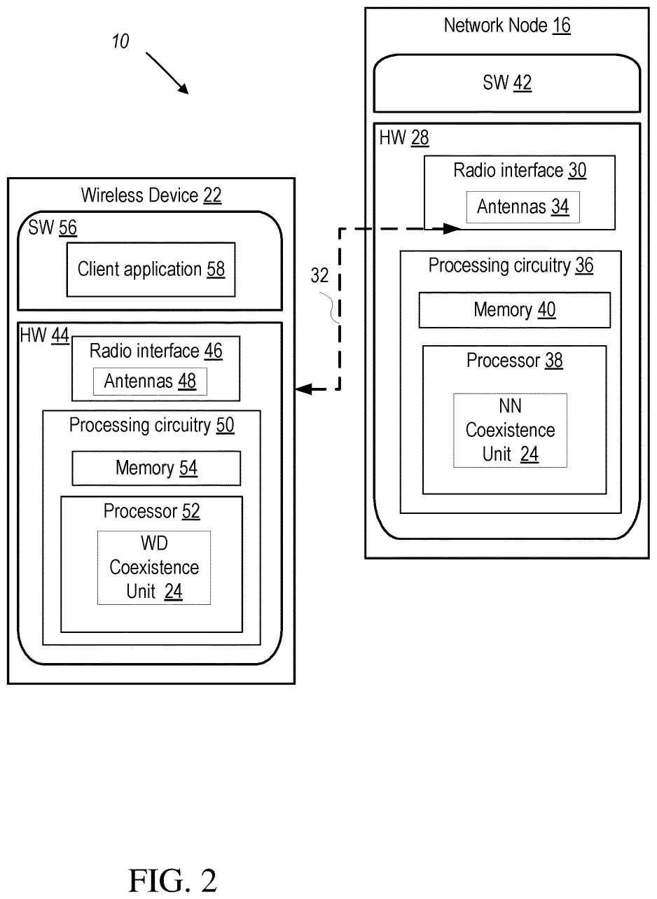

Also note that although network nodes 16 are illustrated as some kind of base stations and the wireless devices 22 are illustrated as some kind of phone, the invention and its principle are by no means limited to such apparatuses and structures. The NNs 16 can be any kind of apparatuses including radio interface etc. as for example demonstrated with reference to FIG. 2 and may operate under suitable communication standard. For example, for the Bluetooth context, the NN 16 will be a Central Device (previously known as Master Device) and the WD 22 will be a Peripheral Device (previously known as Slave Device). Thus, the belonging to either NN 16 or WD 22 can depend on a role that the respective apparatus takes rather than a specific structure of the device. However, the network node 16 and the wireless device 22 may inherently have different structures for other contexts such as for traditional cellular systems as specified e.g., under the 3GPP, or other contexts where devices are dedicated to a certain hierarchical level (nodeB, base station, access point, etc. vs. UE, terminal, (non-AP) station, etc.) of a communication system.

Example implementations, in accordance with an embodiment, of the WD 22 and network node 16 discussed in the preceding paragraphs will now be described with reference to FIG. 2.

The communication system 10 includes a network node 16a provided in a communication system 10 and including hardware 28 enabling it to communicate with the WD 22. The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16. For example, processing circuitry 36 of the network node 16 may include a NN coexistence unit 24, which is configured to perform one or more network node 16 functions described herein, including functions related to channel dependent access priority.

The communication system 10 further includes the WD 22 already referred to. The WD 22 may have hardware 44 that may include a radio interface 46 configured to set up and maintain a wireless connection 32 with one or more network nodes 16a, 16b serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22. For example, the processing circuitry 50 of the wireless device 22 may include a WD coexistence unit 26 which is configured to perform one or more wireless device 22 functions described herein, including functions related to channel dependent access priority.

In some embodiments, the inner workings of the network node 16 and WD 22 may be as shown in FIG. 2 and independently, the surrounding network topology may be that of FIG. 1.

The wireless connection 32 between the WD 22 and the network nodes 16a, 16b is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

Although FIGS. 1 and 2 show various “units,” such as NN coexistence unit 24, WD coexistence unit 26, as being within a respective processor, it is contemplated that these units may be implemented such that a portion of the unit is stored in a corresponding memory within the processing circuitry. In other words, the units may be implemented in hardware or in a combination of hardware and software within the processing circuitry.

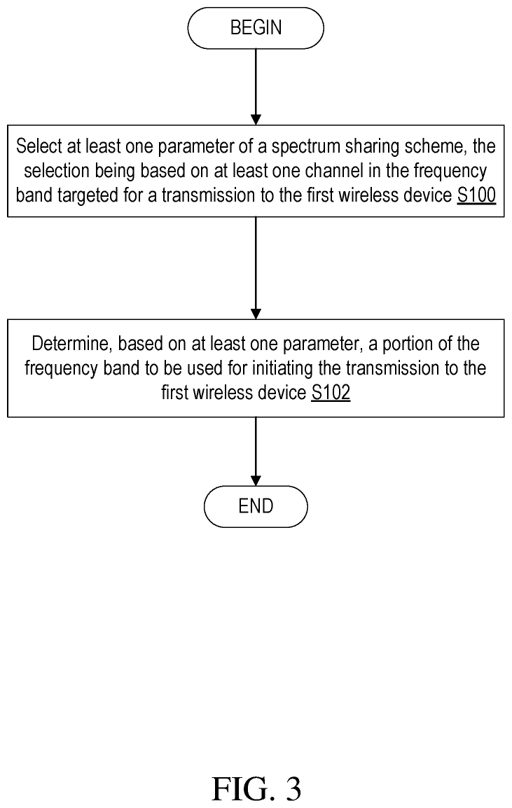

FIG. 3 is a flowchart of an example process in a network node 16 according to some embodiments of the present disclosure. One or more blocks described herein may be performed by one or more elements of network node 16 such as by one or more of processing circuitry 36 (including the NN coexistence unit 24), processor 38, and/or radio interface 30. Network node 16 is configured to select at least one parameter of a spectrum sharing scheme, the selection being based on at least one channel in the frequency band targeted for a transmission to the wireless device 22 (Block S100). Network node 16 is configured to determine, based on at least one parameter, a portion of the frequency band to be used for initiating the transmission to the wireless device 22 (Block S102).

In at least one embodiment, the at least one parameter comprises a first value for a first set of channels of the frequency band and a second value for a second set of channels of the frequency band.

In at least one embodiment, the first set of channels corresponds to a frequency bandwidth that is an integer multiple of a listen before talk, LBT, bandwidth used by the second network node 16 in the frequency band.

In at least one embodiment, the parameter comprises a threshold value, and the determination includes determining, based on the threshold value, whether the channel is idle or busy.

In at least one embodiment, the parameter comprises to at least one of: a threshold value corresponding to whether the channel is idle or busy; a duration of a sensing procedure performed on the channel; and a duration of the transmission after sensing the channel is idle.

In at least one embodiment, the spectrum sharing scheme includes listen before talk, LBT.

In at least one embodiment, network node 16 is configured to communicate according to one of Wi-Fi or Bluetooth, and a second wireless device 22 or second network node 16 is configured to communicate according to the other of Bluetooth or Wi-Fi network node 16.

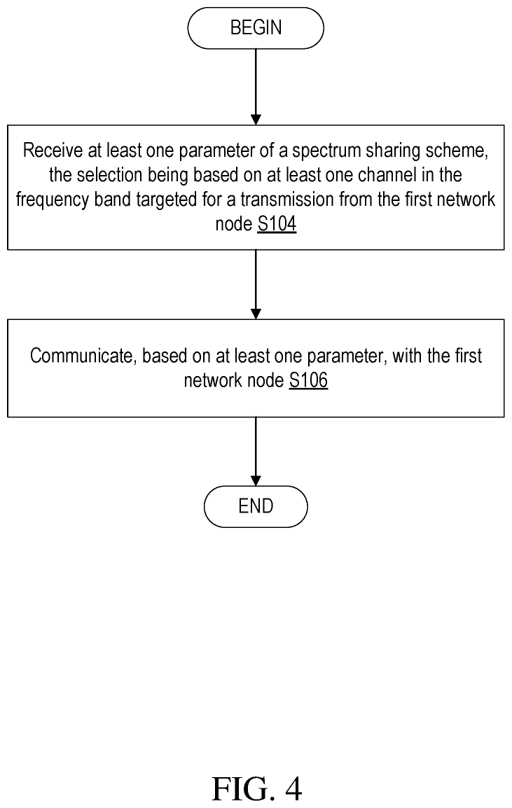

FIG. 4 is a flowchart of an example process in a wireless device 22 according to some embodiments of the present disclosure. One or more blocks described herein may be performed by one or more elements of wireless device 22 such as by one or more of processing circuitry 50 (including the WD coexistence unit 26), processor 52, and/or radio interface 46. Wireless device 22 is configured to receive at least one parameter of a spectrum sharing scheme, the selection being based on at least one channel in the frequency band targeted for a transmission from the network node 16 (Block S104). Wireless device 22 is configured to communicate, based on at least one parameter, with the network node 16 (Block S106).

In at least one embodiment, the at least one parameter comprises a first value for a first set of channels of the frequency band and a second value for a second set of channels of the frequency band.

In at least one embodiment, the first set of channels corresponds to a frequency bandwidth that is an integer multiple of a listen before talk, LBT, bandwidth used by the at least one of second wireless device 22 and second network node 16.

In at least one embodiment, the parameter comprises a threshold value, and the determination includes determining, based on the threshold value, whether the channel is idle or busy.

In at least one embodiment, the parameter comprises to at least one of: a threshold value corresponding to whether the channel is idle or busy; a duration of a sensing procedure performed on the channel; and a duration of the transmission after sensing the channel is idle.

In at least one embodiment, the spectrum sharing scheme includes listen before talk, LBT.

In at least one embodiment, wireless device 22 is configured to communicate according to one of Wi-Fi or Bluetooth, and a second wireless device 22 or second network node 16 is configured to communicate according to the other of Bluetooth or Wi-Fi network node 16.

Having described the general process flow of arrangements of the disclosure and having provided examples of hardware and software arrangements for implementing the processes and functions of the disclosure, the sections below provide details and examples of arrangements for channel dependent access priority. One or more network node 16 functions described below may be performed by one or more of processing circuitry 36, processor 38, NN coexistence unit 24, WD coexistence unit 26, etc.

Embodiments according to the present disclosure may be described in the context of a first system, which may include one or more network node 16 and/or wireless device 22, operating in a frequency band and using frequency hopping (FH) and listen before talk (LBT) to determine whether a channel in the frequency band is idle before transmitting, such as to a network node 16 and/or wireless device 22. The first system may have, e.g., a bandwidth of 4 MHz. Various embodiments also include a second system operating in the same frequency band. The second system, which may include the network node 16b, does not use FH and may use LBT. The second system is relatively wideband compared to the first system, and may be based, e.g., on the IEEE 802.11 standard and may use a bandwidth of 160 MHz. Since FH is not used in the second system, the second system's procedure for LBT may be different than that of the first system. Specifically, the same 160 MHz channel may be used all the time, and as long as the channel is determined to be busy, the transmission is deferred. However, since it may happen that only a part of the 160 MHz channel is busy, the LBT may work on 20 MHz sub-channels such that a 20 MHz sub-channel that is found to be idle may be used, whereas a 20 MHz sub-channel that is found to be busy must not be used. If some 20 MHz sub-channel is not used for transmission, but other 20 MHz sub-channels are used for transmission, this may result in puncturing.

Moreover, the two systems might operate in the lower part of the 6 GHz band, e.g., 5925 MHz to 6425 MHz, totaling 500 MHz.

Although both systems are using LBT, coexistence may be difficult due to the vastly different parameters for the two systems. Specifically, one system (e.g., including a network node 16 and/or wireless device 22) may defer to the other system (e.g., including network node 16b) when both systems could operating concurrently. In addition, a system might not defer from operating when it should. Various embodiments described herein relate to dividing the total available bandwidth between the two systems to mitigate interference. Thus, the total bandwidth is divided so that each of the two systems obtains a bandwidth that is smaller than the total bandwidth, but each portion may be free from interference from the other system. This sharing may be achieved in a way that is as transparent as possible for the involved systems. In other words, a system may select (which can be done autonomously) a part of the band without interaction with the other system. In addition, the division of the spectrum can be dynamic and can account for the load of each of the systems. As a result, if only one of the systems is active, the performance of this system might not be impacted.

For various embodiments described herein, the following may be relevant:
1. The narrowband system (e.g., including a network node 16 and/or wireless device 22) using FH uses a set of frequencies to achieve coexistence with other devices using the same narrowband standard. That is, several links may coexist in parallel by using different hopping patterns. Sometime more than one of the links will use the same frequency, and then a collision may occur. However, if the probability of this is sufficiently small, and the system is using some kind of retransmission protocol, the performance may still be acceptable. To achieve coexistence with the wideband system, the FH system may update the set of frequencies to not use frequencies where the wideband system is operating.
2. The wideband system achieves coexistence between different wideband links using LBT. There are two methods for achieving coexistence with the narrowband system. First, the wideband system may change to another channel somewhere in the band that potentially is less interfered (either by narrowband interference or by wideband interference). Second, the wideband system may apply puncturing. That is, if, e.g., a 160 MHz channel is used, and one or more 20 MHz sub-channels are found to be occupied, the wideband system may puncture the 160 MHz signal and use the 20 MHz channels that are found to be available. In principle, the wideband system may perform LBT and, based on the outcome, prepare a suitable packet for the corresponding transmission following directly after the LBT. However, if the wideband system is able to identify that some of the 20 MHz sub-channels are found to be unavailable relatively often, the wideband system may prepare the packet accordingly before performing the LBT. Since the time between performing LBT and initiating a transmission is very short, only a few us, this may be a more practical approach.
3. When both systems could make use of more spectrum than is available, it may not be sufficient that only one of the systems is (either directly or indirectly) involved.

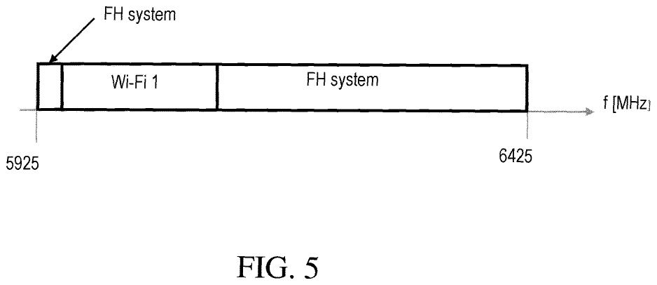

An example situation is provided wherein the wideband system, e.g. via a network node 16 occupies only a part of the total available bandwidth. This is illustrated in FIG. 5. A single 160 MHz Wi-Fi channel centered at 6025 MHz is occupying the 500 MHz wide frequency band between 5925 and 6425 MHz. A FH system that is using the same 500 MHz band can then take this into account when deciding what frequencies to use and avoid the Wi-Fi channel. In this case, the FH system may use the 20 MHz below the Wi-Fi channel as well as the 320 MHz above the Wi-Fi channel, allowing the FH system a total bandwidth of 340 MHz. In this example where the wideband system only uses a relatively small part of the total bandwidth, the coexistence can be achieved independently by the FH system by updating the set of frequencies used for frequency hopping.

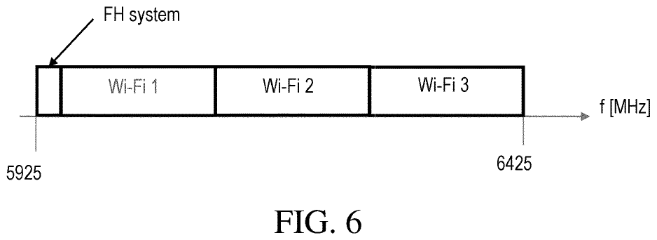

Coexistence may present different challenges when the band is essentially fully occupied by the wideband system, as illustrated in FIG. 6. If the coexistence approach in this case were to rely only on the FH system updating the set of frequencies used for FH to avoid Wi-Fi, only 20 MHz would be available. Not only does this seem unfair, but it may also not be a viable solution because there may be requirements that the FH system use a minimum number of frequencies. If, for example, the FH system is using a bandwidth of 4 MHz, and there is a requirement that at least 15 different (non-overlapping) channels must be used, the minimum bandwidth that the FH system must occupy would be 60 MHz.

In practice, the situation may be even worse. Wi-Fi use may include several access points (APs) within range of one another that use the same channel. One reason for this is that, as the channel bandwidth is increased in Wi-Fi, the number of non-overlapping Wi-Fi channels is severely decreased. As a result, it may not be possible to have a system with sufficiently large frequency reuse. For Wi-Fi, the effect may be that one basic service set (BSS) served by one AP will defer to another BSS on the same channel and served by another AP. This may mean that the two BSSs share the channel in time. Both BSSs will suffer from reduced performance, but the sharing is still fair. BSSs with overlapping coverage areas may be referred to as overlapping BSS (OBSS). OBSS can present difficulties when trying to achieve coexistence between a wideband system like Wi-Fi and a FH system. In the scenario presented in FIG. 6, the FH system cannot avoid the wideband system. In addition, if the FH system is using LBT with another set of parameters than what is used by the wideband system, it may find the channel to always be busy, since the different BSSs effectively can be seen as taking turns on using the channel.

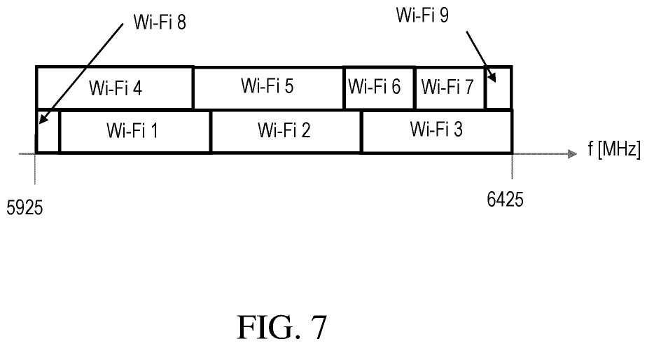

In FIG. 7, a situation with OBSSs is illustrated. There are 9 BSSs, denoted Wi-Fi 1 to Wi-Fi 9. Wi-Fi 1-Wi-Fi 5 are using 160 MHz wide channels, Wi-Fi 6 and Wi-Fi 7 are using 80 MHz channels, and Wi-Fi 8 and Wi-Fi 9 are using 20 MHz channels. It is not possible in this scenario for a FH system to avoid interfering with Wi-Fi. The illustrations in FIG. 6 and FIG. 7 demonstrate that for coexistence to be effective for both systems, both systems should be part of the coexistence mechanism.

The issue illustrated in FIG. 7 may also be present in the other direction, i.e., if many FH links are active at the same time, this will effectively block a wideband system from being able to get access to the channel. In some cases, the wideband system may detect a wideband channel as being busy even if only one narrowband channel is occupied. With many narrowband FH links active, the wideband system performing LBT may always find the wideband channel to be busy.

### Example Embodiments—Channel-dependent Priority

Various embodiments described herein can be used in scenarios where a first system effectively can block a second system from getting channel access. At least one embodiment relates to a method whereby a system uses different channel access priority for different parts of the band. The first system, which may include a network node 16 and/or wireless device 22 may be a FH system, however, the principles described herein may also be applied if the first system is a wideband system. Thus, a second system is the other of FH or wideband depending on the type of the first

In an example scenario, the FH system is using LBT before transmitting on a channel, and the threshold where the channel is considered to be busy is relatively high in the lower 80 MHz of the band and relatively low at the remaining upper part of the band. For example, the threshold for the lower 80 MHz may be set to −60 dBm per 4 MHz in the narrowband channel, whereas it may be set to −90 dBm per 4 MHz in the remaining upper part of the band.

In this scenario, the FH system may not detect a wideband signal in the lower 80 MHz of the band, but it may detect a wideband signal in the upper part of the band. This can result in the FH system first skipping the channels in the upper part of the band and subsequently adapting the set of hopping channels to the frequencies that are useable, i.e., the lower 80 MHz. At the same time, since the FH system will only use the lower 80 MHz, deferring to the wideband system in the upper part of the band, the wideband system will find the lower 80 MHz of the band to be unsuitable due to interference and will therefore avoid using this part of the band.

Avoiding using this part of the band may, e.g., mean that an AP using this part of the band decides to move to another channel that is not overlapping with the lower 80 MHz, or it may mean that the AP punctures the part of the channel that overlaps with the lower 80 MHz. If, e.g., the wideband system is a Wi-Fi system with a 160 MHz wide channel centered at 6025, as illustrated in FIG. 5, this may mean that the lower 60 MHz would be punctured, and, effectively, the BSS would use a channel bandwidth of 100 MHz.

If the wideband system is a Wi-Fi system based on, e.g., the IEEE 802.11 standard, the LBT may be done with 20 MHz granularity. In this case, the FH system may take this into account when selecting the bandwidths with which to use the different priorities. Specifically, the FH system may use the higher channel access priority for a channel bandwidth of a multiple of 20 MHz, e.g., 80 MHz.

Alternatively, the FH system may use the lower channel access priority for a multiple of 20 MHz, e.g., 320 MHz.

In the above example, two different thresholds are used for obtaining different priorities. A special case of this would be that the higher priority may be obtained without using LBT at all, which may be achieved by setting the threshold sufficiently high so that the channel would not be found to be busy.

In the above example, the different priorities may be achieved by using different thresholds for declaring the channel to be idle. In at least one embodiment, different priorities may be determined by using different durations for how long to listen to an idle channel before a transmission. For example, the FH system may listen for 100 μs on the channel to detect an ongoing transmission before starting its own transmission. Thus, the FH system may only access the channel if the Wi-Fi devices leave large gaps and are not using the channel extensively. In particular, if two Wi-Fi devices are executing a frame exchange sequence, in which the frames are usually separated by at most 16 μs (the “Short InterFrameSpace” (SIFS)), the FH device may never detect the channel as idle. Now, to increase the priority of the FH system in some of the channels, the 100 μs listening duration may be reduced to, e.g., 10 μs. This has a similar effect as increasing the detection power threshold as described above. The probability of observing an idle channel is increased, and thus the FH system can occupy these channels more often and eventually change its channel hopping plan to avoid the other channels.

Various embodiments implement different priorities for the different parts of the frequency band by adjusting the channel listening durations for the wide-band system instead of the narrow-band system. As an example, if the wideband system (e.g., including a network node 16 and/or wireless device 22) is based on Wi-Fi, a prioritization may be obtained if, e.g., the usage of the complete wideband channel is limited to traffic with a low priority access category (AC), using large backoff durations. Transmissions of the high priority AC that tend to have very small backoff durations may be limited to use the upper part only. In this way, the FH system maya have higher chance to find an idle channel in the lower power of the band.

At least one embodiment uses a maximum duration of the transmission parameter to tune the aggressiveness of the channel access. If this duration is short, then the device (e.g. wireless device 22 or network node 16) may sense the channel more often to transmit a certain amount of data. This may increase the probability of detect other transmissions, forcing the device to back off more often. A longer duration, however may block the channel for a longer time and thus will force other systems to defer to the channel access with higher probability.

While one or more embodiments have been described with respect to non-cellular or non-3GPP standards, the teachings described herein may be applicable to 3GPP standards/cellular standards, and/or a combination of cellular and non-cellular standards.

### Some Examples

Example 1. A spectrum sharing mechanism for a first standard in a frequency band, where at least one of the parameters in the spectrum sharing mechanism is dependent on which channel in the frequency band is targeted for transmission.
Example 2. Example 1, where the parameter is selected to have a first value for a first set of channels in the band and to have a second value for a second set of channels in the band.
Example 3. Example 2, where the first value and second value are related such that there is a higher likelihood that a transmission can be initiated if the first value is used.
Example 4. Any of Examples 1-3, where the parameter relates to the threshold value used for determining whether the channel should be considered to be idle or busy.
Example 5. Any of Examples 1-4 where the parameter relates to the duration of the channel sensing.
Example 6. Any of Examples 1-5 where the parameter relates to the duration of the transmission after sensing the channel as idle.
Example 7. Any of Examples 1-6 where the spectrum sharing mechanism of the first standard is at least in part based on listen before talk (LBT).
Example 8. Any of Examples 1-7 where the first set of channels corresponds to frequency bandwidth that is an integer multiple of the LBT bandwidth used for a second standard used in the same frequency band.
Example 9. Examples 6, where the LBT bandwidth is 20 MHz.
Example 10. Examples 6, where the second standard is based on IEEE 802.11.
Example 11. Any of Examples 1-10, where the first standard is using frequency hopping.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings.

### Example Embodiments

Embodiment A1. A first network node configured to communicate with a first wireless device (WD) on a frequency band, the frequency band being shared with at least one of a second wireless device and a second network node, the first network node being configured to, and/or comprising a radio interface and/or comprising processing circuitry configured to:
select at least one parameter of a spectrum sharing scheme, the selection being based on at least one channel in the frequency band targeted for a transmission to the first wireless device; and
determine, based on at least one parameter, a portion of the frequency band to be used for initiating the transmission to the first wireless device.

Embodiment A2. The first network node of Embodiment A1, wherein the at least one parameter comprises a first value for a first set of channels of the frequency band and a second value for a second set of channels of the frequency band.

Embodiment A3. The first network node of Embodiment A2, wherein the first set of channels corresponds to a frequency bandwidth that is an integer multiple of a listen before talk, LBT, bandwidth used by the at least one of second wireless device and second network node.

Embodiment A4. The first network node of any one of Embodiments A1-A3, wherein the parameter comprises to at least one of:
a threshold value corresponding to whether the channel is idle or busy;
a duration of a sensing procedure performed on the channel; and
a duration of the transmission after sensing the channel is idle.

Embodiment A5. The first network node of any one of Embodiments A1-A4, wherein the spectrum sharing scheme comprises listen before talk, LBT.

Embodiment A6. The first network node of any one of Embodiments A1-A5, wherein the first network node is configured to communicate according to one of Wi-Fi or Bluetooth, and the at least one second wireless device or second network node is configured to communicate according to the other of Bluetooth or Wi-Fi network node.

Embodiment B1. A method implemented in a first network node that is configured to communicate with a first wireless device on a frequency band, the frequency band being shared with at least one of a second wireless device and a second network node, the method comprising:
selecting at least one parameter of a spectrum sharing scheme, the selection being based on at least one channel in the frequency band targeted for a transmission to the first wireless device; and
determining, based on at least one parameter, a portion of the frequency band to be used for initiating the transmission to the first wireless device.

Embodiment B2. The method of Embodiment B1, wherein the at least one parameter comprises a first value for a first set of channels of the frequency band and a second value for a second set of channels of the frequency band.

Embodiment B3. The method of Embodiment B2, wherein the first set of channels corresponds to a frequency bandwidth that is an integer multiple of a listen before talk, LBT, bandwidth used by the at least one of second wireless device and second network node.

Embodiment B4. The method of any one of Embodiments B1-B3, wherein the parameter comprises to at least one of:
a threshold value corresponding to whether the channel is idle or busy;
a duration of a sensing procedure performed on the channel; and
a duration of the transmission after sensing the channel is idle.

Embodiment B5. The method of any one of Embodiments B1-B4, wherein the spectrum sharing scheme comprises listen before talk, LBT.

Embodiment B6. The method of any one of Embodiments A1-A5, wherein the first network node is configured to communicate according to one of Wi-Fi or Bluetooth, and the at least one second wireless device or second network node is configured to communicate according to the other of Bluetooth or Wi-Fi network node.

Embodiment C1. A first wireless device (WD) configured to communicate with a first network node on a frequency band, the frequency band being shared with at least one of a second wireless device and a second network node, the first WD configured to, and/or comprising a radio interface and/or processing circuitry configured to:
receive at least one parameter of a spectrum sharing scheme, the selection being based on at least one channel in the frequency band targeted for a transmission from the first network node; and
communicate, based on at least one parameter, with the first network node.

Embodiment C2. The first wireless device of Embodiment C1, wherein the at least one parameter comprises a first value for a first set of channels of the frequency band and a second value for a second set of channels of the frequency band.

Embodiment C3. The first wireless device of Embodiment C2, wherein the first set of channels corresponds to a frequency bandwidth that is an integer multiple of a listen before talk, LBT, bandwidth used by the at least one of second wireless device and second network node.

Embodiment C4. The first wireless device of any one of Embodiments C1-C3, wherein the parameter comprises to at least one of:
a threshold value corresponding to whether the channel is idle or busy;
a duration of a sensing procedure performed on the channel; and
a duration of the transmission after sensing the channel is idle.

Embodiment C5. The first wireless device of any one of Embodiments C1-C4, wherein the spectrum sharing scheme comprises listen before talk, LBT.

Embodiment C6. The first wireless device of any one of Embodiments C1-C5, wherein the first wireless device is configured to communicate according to one of Wi-Fi or Bluetooth, and the at least one second wireless device or second network node is configured to communicate according to the other of Bluetooth or Wi-Fi network node.

Embodiment D1. A method implemented in a first wireless device that is configured to communicate with a first network node on a frequency band, the frequency band being shared with at least one of a second wireless device and a second network node, the method comprising:
receiving at least one parameter of a spectrum sharing scheme, the selection being based on at least one channel in the frequency band targeted for a transmission from the first network node; and
communicating, based on at least one parameter, with the first network node.

Embodiment D2. The method of Embodiment D1, wherein the at least one parameter comprises a first value for a first set of channels of the frequency band and a second value for a second set of channels of the frequency band.

Embodiment D3. The method of Embodiment D2, wherein the first set of channels corresponds to a frequency bandwidth that is an integer multiple of a listen before talk, LBT, bandwidth used by the at least one of second wireless device and second network node.

Embodiment D4. The method of any one of Embodiments D1-D3, wherein the parameter comprises to at least one of:
a threshold value corresponding to whether the channel is idle or busy;
a duration of a sensing procedure performed on the channel; and
a duration of the transmission after sensing the channel is idle.

Embodiment D5. The method of any one of Embodiments D1-D4, wherein the spectrum sharing scheme comprises listen before talk, LBT.

Embodiment D6. The method of any one of Embodiments D1-D5, wherein the first wireless device is configured to communicate according to one of Wi-Fi or Bluetooth, and the at least one second wireless device or second network node is configured to communicate according to the other of Bluetooth or Wi-Fi network node.

1. A first device configured to communicate with a second device in a first communication system on a frequency band, the first comprising a radio interface and processing circuitry configured to:
perform a transmission, based on at least one parameter of a spectrum sharing scheme, to the second device, the at least one parameter of a spectrum sharing scheme being based on a channel in the frequency band targeted for the transmission to the second device.

2. The first device of claim 1, wherein the frequency band is shared with at least one third device in a second communication system.

3. The first device of claim 1, wherein the first device is a network node, and the second device is a wireless device.

4. The first device of claim 1, wherein the first device is a central device, and the second device is a peripheral device.

5. The first device of claim 1, wherein the first device being configured to base a portion of the frequency band to be used for initiating the transmission to the second device on the at least one parameter.

6. The first device of claim 2, wherein the first device and the second device are configured to communicate according to one of Wi-Fi or Bluetooth, and the at least one third device is configured to communicate according to the other of Bluetooth or Wi-Fi.

7. (canceled)

8. The first device of claim 2, wherein the frequency band comprises a first set of channels, and wherein the first set of channels corresponds to a frequency bandwidth that is an integer multiple of a listen before talk, LBT, bandwidth used by the at least one third device in the second communication system.

9. (canceled)

10. The first device of claim 1, wherein the parameter corresponds to at least one of:
a threshold value corresponding to whether the channel is determined to be idle or busy;
a duration of a sensing procedure performed on the channel; and
a duration of the transmission after sensing the channel is idle.

11. The first device of claim 1, wherein the spectrum sharing scheme comprises listen before talk.

12. The first device of claim 1, wherein the spectrum sharing scheme comprises frequency hopping.

13. A method implemented in a first device that is configured to communicate with a second device in a first communication system on a frequency band, the method comprising:
performing a transmission, based on at least one parameter of a spectrum sharing scheme, to the second device, the at least one parameter of a spectrum sharing scheme being based on a channel in the frequency band targeted for the transmission to the second device.

14. The method of claim 13, wherein the frequency band is shared with at least one third device in a second communication system.

15. The method of claim 13, wherein the first device is a network node, and the second device is a wireless device.

16. The method of claim 13, wherein the first device is a central device, and the second device is a peripheral device.

17. The method of claim 13, wherein the first device is configured to base a portion of the frequency band to be used for initiating the transmission to the second device on the at least one parameter.

18. The method of claim 14, wherein the first device and the second device are configured to communicate according to one of Wi-Fi or Bluetooth, and the at least one third device is configured to communicate according to the other of Bluetooth or Wi-Fi.

19. (canceled)

20. The method of claim 14, wherein the frequency band comprises a first set of channels, and wherein the first set of channels corresponds to a frequency bandwidth that is an integer multiple of a listen before talk, LBT, bandwidth used by the at least one third device in the second communication system.

21. (canceled)

22. The method of claim 13, wherein the parameter corresponds to at least one of:
a threshold value corresponding to whether the channel is determined to be idle or busy;
a duration of a sensing procedure performed on the channel; and
a duration of the transmission after sensing the channel is idle.

23. The method of claim 13, wherein the spectrum sharing scheme comprises listen before talk.

24. The method of claim 13, wherein the spectrum sharing scheme comprises frequency hopping.
